(19) United States
(12) Patent Application Publication
(10) Pub. No.: US 2014/0219375 A1
(43) Pub. Date: Aug. 7, 2014

(54) METHOD AND DEVICE FOR FEEDING BACK CHANNEL INFORMATION

(71) Applicants: Dengkui Zhu, Shenzhen (CN); Zhaohua Lu, Shenzhen (CN)

(72) Inventors: Dengkui Zhu, Shenzhen (CN); Zhaohua Lu, Shenzhen (CN)

(21) Appl. No.: 14/130,067

(22) PCT Filed: Dec. 27, 2011
(86) PCT No.: PCT/CN2011/084755

§ 371 Date: Apr. 10, 2014

(30) Foreign Application Priority Data
Jun. 30, 2011 (CN) 201110182435.9

(51) Int. Cl. H04L 25/03; H04L 12/26

(52) U.S. Cl. CPC H04L 25/0391; H04L 43/065
USPC 375/267

(57) ABSTRACT

Disclosed are a method and device for feeding back channel state information. The method includes: generating a first codebook by using the number of antennae in each row of a planar antenna array; generating a second codebook by using the number of columns of the planar antenna array; and feeding back the channel state information by using the first codebook and the second codebook. The solution of the disclosure improves system robustness.

### CROSS-REFERENCE TO RELATED APPLICATION

This application is a U.S. National Phase application from International PCT Application No. PCT/CN2011/084755 filed on Dec. 27, 2011 which claimed benefit of Chinese Patent Application No. 201110182435.9 filed Jun. 30, 2011. The entire disclosure of the above applications are incorporated herein by reference.

### TECHNICAL FIELD

The disclosure relates to the field of communications, in particular to a method and device for feeding back channel information.

### BACKGROUND OF THE INVENTION

With the development of wireless communication technologies, an array antenna is more and more widely applied in the wireless communication technologies. It has already had a considerable application in configuring a linear array antenna (FIGS. 1 and FIG. 2) in a system equipment (a base station, a centralized control processing unit or a relay, etc.) side so as to use a beamforming technology to increase the coverage area of a cell and improve spectrum efficiency. The beamforming technology mainly utilizes electromagnetic wave propagation with a strong directivity between a terminal and system equipment, performs pre-processing at a sending end to form a beam pointing to the terminal direction and achieves the coherence superposition of signals, so as to increase a received power. However, such a traditional beamforming technology mainly considers the beamforming technology in a horizontal direction, i.e. mainly using a horizontal orientation angle to differentiate users and form a beam, while there is no beam direction in a vertical direction, this leads to the problem that the users at the edge of adjacent cells and respectively belonging to two cells have strong interference therebetween, especially when the beams of the users have the same orientation angle. In order to avoid the interference among users having the same horizontal orientation angle more flexibly, the vertical orientation angle is used to complete this function such that the beam directions of the users have two parameters of both the horizontal angle and the vertical angle, thus increasing the flexibility of avoiding the interference.

Such a beamforming technology by means of using both the horizontal orientation angle and the vertical orientation angle is also known as the 3D beamforming. Generally speaking, such a technology requires that the antennae cannot be arranged as a linear array anymore, but arranged in two mutually perpendicular directions in order to form a planar may, as shown in FIG. 3.

However, as regards the above-mentioned planar antenna array, the solution of codebook quantization is not proposed in related technologies, and therefore, channel state information cannot be transmitted through an effective quantization channel coefficient, thus resulting in the problem of a low system robustness.

### SUMMARY OF THE INVENTION

The disclosure provides a method and device for feeding back channel state information, which can at least solve the above-mentioned problem.

According to an aspect of the disclosure, a method for feeding back channel information is provided, and the method includes: generating a first codebook by using the number of antennae in each row of a planar antenna array; generating a second codebook by using the number of columns of the planar antenna array; and feeding back channel state information by using the first codebook and the second codebook.

Preferably, generating the first codebook by using the number of antennae in each row of the planar antenna array includes: constructing K₁ complex matrices of Nₓ×r, wherein K₁ is the number of matrices of a quantification channel, and takes the value of a natural number, and Nₓ is the number of the antennae in each row of the planar antenna array, 1≦r≦Nₓ, and respective columns of each complex matrix are mutually orthogonal.

Preferably, generating the second codebook by using the number of columns of the planar antenna array includes: constructing K₂ unit column vectors of N_{y}×1, wherein N_{y} is the number of columns of the planar antenna array.

Preferably, constructing K₂ unit column vectors of N_{y}×1 includes: constructing column vector C2 by means of one of the following formulas:

$${C}_{2} = {\frac{1}{\sqrt{{N}_{y}}} [ \begin{matrix}1 & {e}^{jϕ} & … & {e}^{- j ( {N}_{y} - 1 ) ϕ}\end{matrix} ]}^{T} ;$$

$$and$$

$${C}_{2} = {\frac{1}{\sqrt{{\sum }_{i = 1}^{{N}_{y}} {\vert {c}_{i} \vert}^{2}}} [ \begin{matrix}{c}_{1} & {c}_{2} & … & {c}_{{N}_{y}}\end{matrix} ]}^{T} ,$$

wherein φ presents a vector angle, and c₁, c₂ . . . c_{N}_{_{y}} are complex numbers.

Preferably, feeding back the channel state information by using the first codebook and the second codebook includes: calculating Kronecker product of the first codebook and the second codebook or calculating Kronecker product of the second codebook and the first codebook to get a third codebook; and feeding back a third index, wherein the third index is a corresponding index of quantized channel state information in the third codebook; or respectively feeding back a first index and a second index, wherein the first index is a corresponding index of the quantized channel state information in the first codebook, and the second index is a corresponding index of the quantized channel state information in the second codebook.

According to another aspect of the disclosure, a device for feeding back channel state information is provided, and the device includes: a first generation module configured to generate a first codebook by using the number of antennae in each row of a planar antenna array; a second generation module configured to generate a second codebook by using the number of columns of the planar antenna array; and a first feedback module configured to feed back channel state information by using the first codebook and the second codebook.

Preferably, the first generation module includes: a first construction module configured to construct K₁ complex matrices of Nₓ×r, wherein K₁ is the number of matrices of a quantification channel, and takes the value of a natural number, and Nₓ is the number of the antennae in each row of the planar antenna array, 1≦r≦Nₓ, and respective columns of each complex matrix are mutually orthogonal.

Preferably, the second generation module includes: a second construction module configured to construct K₂ unit column vectors of N_{y}×1, wherein N_{y} is the number of columns of the planar antenna array.

Preferably, the second construction module is configured to construct column vector C2 by means of one of the following formulas:

$${C}_{2} = {\frac{1}{\sqrt{{N}_{y}}} [ \begin{matrix}1 & {e}^{jϕ} & … & {e}^{- j ( {N}_{y} - 1 ) ϕ}\end{matrix} ]}^{T} ;$$

$$and$$

$${C}_{2} = {\frac{1}{\sqrt{{\sum }_{i = 1}^{{N}_{y}} {\vert {c}_{i} \vert}^{2}}} [ \begin{matrix}{c}_{1} & {c}_{2} & … & {c}_{{N}_{y}}\end{matrix} ]}^{T} ,$$

wherein φ presents a vector angle, and c₁ c₂ . . . c_{N}_{_{y}} are complex numbers.

Preferably, the first feedback module includes: a processing module configured to calculate Kronecker product of the first codebook and the second codebook or calculate Kronecker product of the second codebook and the first codebook to get a third codebook; and a second feedback module configured to feed back a third index, wherein the third index is a corresponding index of quantized channel state information in the third codebook; or a third feedback module configured to respectively feed back a first index and a second index, wherein the first index is a corresponding index of the quantized channel state information in the first codebook, and the second index is a corresponding index of the quantized channel state information in the second codebook.

According to still another aspect of the disclosure, a method for feeding back channel state information is provided, and the method includes: generating a first codebook by using a first parameter of an antenna array; generating a second codebook by using a second parameter of the antenna array; and feeding back channel state information by using the first codebook and the second codebook, or by using a third codebook generated by the first codebook and the second codebook; wherein the product of the first parameter and the second parameter is the number of parameters contained in the antenna array, and the first parameter and the second parameter are natural numbers.

Preferably, the first parameter is the number of antennae in each row of the antenna array, and the second parameter is the number of antennae in each column of the antenna array; or the first parameter is the number of the antennae in each column of the antenna array, and the second parameter is the number of the antennae in each row of the antenna array; the first parameter is the number of loops when the antenna array is placed as a circular array, and the second parameter is the number of antennae in each loop of the antenna array; the first parameter is the number of antennae in each loop of the antenna array, and the second parameter is the number of loops when the antenna array is placed as a circular array.

According to still another aspect of the disclosure, a device for feeding back channel state information is provided, and the device includes: a third generation module configured to generate a first codebook by using a first parameter of an antenna array; a fourth generation module configured to generate a second codebook by using a second parameter of the antenna array; and a second feedback module configured to feed back channel state information by using the first codebook and the second codebook, or by using a third codebook generated by the first codebook and the second codebook; wherein the product of the first parameter and the second parameter is the number of parameters contained in the antenna array, and the first parameter and the second parameter are natural numbers.

By means of respectively using the number of columns of the planar antenna array and the number of antennae in each row of the planar antenna array to generate codebooks respectively and feeding back the channel state information, the disclosure realizes the effective quantization channel coefficient, overcomes the problem that channel state information cannot be fed back when using planar antenna array in related technologies, and achieves the effect of improving system robustness.

### BRIEF DESCRIPTION OF THE DRAWINGS

Drawings, provided for further understanding of the disclosure and forming a part of the specification, are used to explain the disclosure together with embodiments of the disclosure rather than to limit the disclosure. In the drawings:

FIG. 1 is a schematic diagram 1 of an antenna placing manner according to the related technologies;

FIG. 2 is a schematic diagram 2 of an antenna placing manner according to the related technologies;

FIG. 3 is a schematic diagram 3 of an antenna placing manner according to the related technologies;

FIG. 4 is a flow diagram of a method for feeding back channel state information according to an embodiment of the disclosure;

FIG. 5 is a structure diagram of a device for feeding back channel state information according to an embodiment of the disclosure;

FIG. 6 is a preferred structure diagram of a device for feeding back channel state information according to an embodiment of the disclosure;

FIG. 7 is a schematic diagram of an antenna manner according to an embodiment of the disclosure;

FIG. 8 is a schematic diagram 1 of a circular antenna placing manner according to an embodiment of the disclosure; and

FIG. 9 is a schematic diagram 2 of a circular antenna placing manner according to an embodiment of the disclosure.

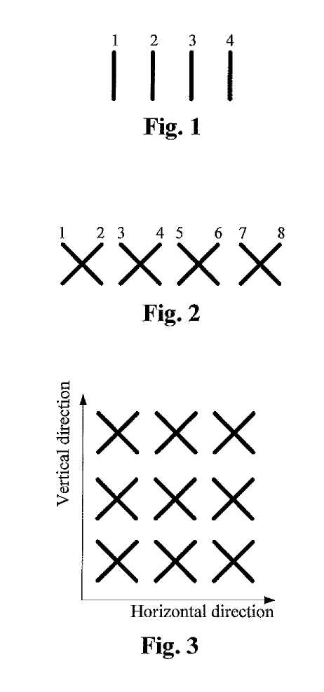

### DETAILED DESCRIPTION OF THE EMBODIMENTS

The disclosure is described below with reference to the accompanying drawings and embodiments in detail. Note that, the embodiments of the disclosure and the features of the embodiments can be combined with each other if there is no conflict.

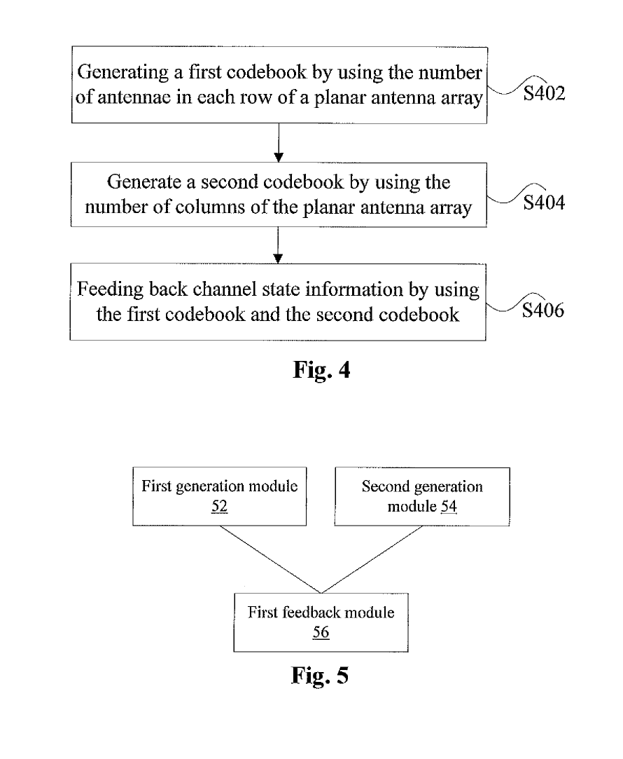

This embodiment provides a method for feeding back channel state information. FIG. 4 is a flow diagram of a method for feeding back channel state information according to an embodiment of the disclosure, and the method includes the following Step S402 to Step S406.

Step S402: a first codebook is generated by using the number of antennae in each row of a planar antenna array.

Step S404: a second codebook is generated by using the number of columns of the planar antenna array.

Step S406: channel state information is fed back by using the first codebook and the second codebook.

By means of respectively using the number of the columns of the planar antenna array and the number of antennae in each row of the planar antenna array to generate codebooks respectively and feeding back the channel state information, the above-mentioned steps realize the effective quantization channel coefficient, overcome the problem that channel state information cannot be fed back when using planar antenna array in related technologies, and achieve the effect of improving system robustness.

In a preferred embodiment, generating the first codebook by using the number of antennae in each row of the planar antenna array includes: K₁ complex matrices of Nₓ×r are constructed, wherein K₁ is the number of matrices of a quantification channel, and takes the value of a natural number, and Nₓ is the number of the antennae in each row of the planar antenna array, 1≦r≦Nₓ, and respective columns of each complex matrix are mutually orthogonal.

In another preferred embodiment, generating the second codebook by using the number of the columns of the planar antenna array includes: K₂ unit column vectors of N_{y}×1 are constructed, wherein N_{y} is the number of the columns of the planar antenna array. More preferably, constructing K₂ unit column vectors of N_{y}×1 includes: column vector C2 is constructed by means of one of the following formulas:

$${C}_{2} = {\frac{1}{\sqrt{{N}_{y}}} [ \begin{matrix}1 & {e}^{jϕ} & … & {e}^{- j ( {N}_{y} - 1 ) ϕ}\end{matrix} ]}^{T} ;$$

$$and$$

$${C}_{2} = {\frac{1}{\sqrt{{\sum }_{i = 1}^{{N}_{y}} {\vert {c}_{i} \vert}^{2}}} [ \begin{matrix}{c}_{1} & {c}_{2} & … & {c}_{{N}_{y}}\end{matrix} ]}^{T} ,$$

wherein φ presents a vector angle (for example, a wave incident angle presented by a column vector), and c₁ c₂ . . . c_{N}_{_{y}} are complex numbers.

There can be various embodiments when feeding back the channel state information by using the first codebook and the second codebook, and more preferably, the following two embodiments can be used.

### Embodiment I

Kronecker product of the first codebook and the second codebook or

Kronecker product of the second codebook and the first codebook is calculated to get a third codebook; and a third index is fed back, wherein the third index is a corresponding index of quantized channel state information in the third codebook.

### Embodiment II

a first index and a second index are respectively fed back, wherein the first index is a corresponding index of quantized channel state information in the first codebook, and the second index is a corresponding index of quantized channel state information in the second codebook.

It should be noted that, the index of only one codebook is required to be fed back in Embodiment I, which is relatively simple in the procedure. In Embodiment II, indexes of two codebooks are fed back; during implementation, the first codebook can be set by default, and only the second codebook is fed back, or the first codebook can be fed back in the first time and the second codebook is fed back in the second time, and this implementation is more flexible and reduces the expenditure of feeding back.

It should be noted that the steps shown in the flowchart of the drawings can be executed, for example, in a computer system with a set of instructions executable by a computer, in addition, a logic order is shown in the flowchart, but the shown or described steps can be executed in a different order under some conditions.

In another embodiment, software for feeding back channel state information is also provided, wherein the software is used for executing the technical solutions described in the above-mentioned embodiments and preferred embodiments.

In another embodiment, a storage medium is also provided, wherein the storage medium stores the above-mentioned software for feeding back channel state information therein, and the storage medium includes, but is not limited to an optical disk, a floppy disk, a hard disk, an erasable storage, etc.

The embodiment of the disclosure further provides a device for feeding back channel state information, wherein the device for feeding back channel state information can be used for realizing the above-mentioned method for feeding back channel state information and preferred embodiments thereof, which have been described and will not provide unnecessary details, the modules related to the device for feeding back channel state information will be described below. The term “module” as used below can realize the combination of pre-set functional software and/or hardware. Although the system and method described by the following embodiments are better realized through the software; however, the hardware, or the implementation of the combination of the software and the hardware is also possible and conceivable.

FIG. 5 is a structure diagram of a device for feeding back channel state information according to an embodiment of the disclosure. As shown in FIG. 5, the device includes: a first generation module 52, a second generation module 54 and a first feedback module 56, and the above-mentioned structures will be described below.

The first generation module 52 is configured to generate a first codebook by using the number of antennae in each row of a planar antenna array; the second generation module 54 is configured to generate a second codebook by using the number of columns of the planar antenna array; and the first feedback module 56 is coupled with the first generation module 52 and the second generation module 54 and is configured to feed back channel state information by using the first codebook generated by the first generation module 52 and the second codebook generated by the second generation module 54.

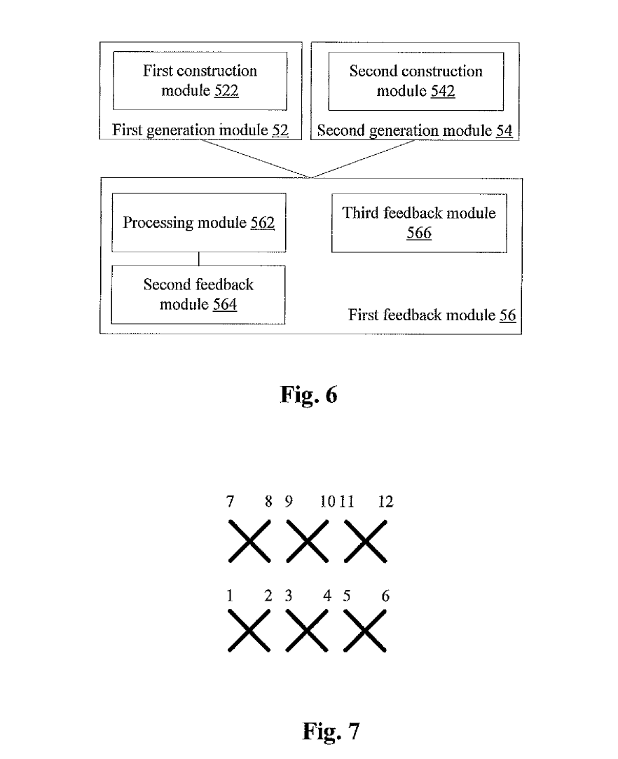

FIG. 6 is a preferred structure diagram of a device for feeding back channel state information according to an embodiment of the disclosure. As shown in FIG. 6, the first generation module 52 includes: a first construction module 522; the second generation module 54 includes: a second construction module 542; and the first feedback module 56 includes: a processing module 562, a second feedback module 564 and a third feedback module 566, and the above-mentioned structures will be described below.

The first construction module 522 is configured to construct K₁ complex matrices of Nₓ×r, wherein K₁ is the number of matrices of a quantification channel, and takes the value of a natural number, and Nₓ is the number of the antennae in each row of the planar antenna array, 1≦r≦Nₓ, and respective columns of each complex matrix are mutually orthogonal.

The second generation module 54 includes: a second construction module 542 configured to construct K₂ unit column vectors of N_{y}×1, wherein N_{y} is the number of the columns of the planar antenna array.

In a preferred embodiment, the second construction module is configured to construct column vector C2 by means of one of the following formulas:

$${C}_{2} = {\frac{1}{\sqrt{{N}_{y}}} [ \begin{matrix}1 & {e}^{jϕ} & … & {e}^{- j ( {N}_{y} - 1 ) ϕ}\end{matrix} ]}^{T} ;$$

$$and$$

$${C}_{2} = {\frac{1}{\sqrt{{\sum }_{i = 1}^{{N}_{y}} {\vert {c}_{i} \vert}^{2}}} [ \begin{matrix}{c}_{1} & {c}_{2} & … & {c}_{{N}_{y}}\end{matrix} ]}^{T} ,$$

wherein φ presents a vector angle, and c₁ c₂ . . . c_{N} are complex numbers.

The first feedback module 56 includes: a processing module 562 configured to calculate Kronecker product of the first codebook and the second codebook or calculate Kronecker product of the second codebook and the first codebook to get a third codebook; and a second feedback module 564 coupled with the processing module 562 and configured to feed back a third index, wherein the third index is a corresponding index of quantized channel state information in the third codebook obtained by the processing module 562; or a third feedback module 566 configured to respectively feed back a first index and a second index, wherein the first index is a corresponding index of quantized channel state information in the first codebook, and the second index is a corresponding index of quantized channel state information in the second codebook.

It will be described with reference to the preferred embodiments below, and the following preferred embodiments are with reference to the above-mentioned embodiments and preferred embodiments.

### Preferable Embodiment I

This embodiment provides a codebook construction method and feedback method, thus increasing the capacity and efficiency of the communication system provided with a planar antenna array. In this embodiment, it is assumed that the system equipment is provided with Nₜ transmitting antennae, which can be resolved into Nₜ=Nₓ×N_{y}, wherein both Nₓ and N_{y} are natural numbers, and the terminal has Nᵣ receiving antennae.

Two solutions as follows for constructing a codebook are used in this embodiment.

Solution I: This solution includes the following steps.

Step S702: a set of codebooks or a set of code words are predefined in a terminal and system equipment of a communication system, wherein the codebooks are formed by a first codebook C₁ and a second codebook C₂.

Specifically, the first codebook C₁ contains K₁ complex matrices of Nₓ×r (1≦r≦Nₓ) and respective columns of each matrix are mutually orthogonal;

wherein C₂ contains K₂ unit column vectors of N_{y}×1, preferably, column vector C₂ can be represented as

$${C}_{2} = \frac{1}{\sqrt{{N}_{y}}} [ \begin{matrix}1 & {e}^{j 2 πϕ} & … & {{e}^{- j 2 π ( {N}_{y} - 1 ) ϕ} ]}^{T} .\end{matrix}$$

Certainly, C₂ can also be any other complex vectors:

$${C}_{2} = {\frac{1}{\sqrt{{\sum }_{i = 1}^{{N}_{y}} {\vert {c}_{i} \vert}^{2}}} [ {c}_{1} {c}_{2} … {c}_{{N}_{T}} ]}^{T} .$$

Each code word of codebook C has the following forms:

Cᵢ=C₁ [symbol] C₂ or Cᵢ=C₂ [symbol] C₁, i=0, . . . , K₁K₂−1, wherein [symbol] represents Kronecker product, wherein C₁ [symbol] C₂ represents that each element in C₁ is multiplied by C₂, and finally a matrix of NₓN_{y}×r is formed.

Step S704: after the terminal obtains a channel coefficient H, the H is quantized as code word Cₖ, the index of which is k in the codebook C, and the index k is fed back to the system equipment by using a feedback channel.

Solution II: This solution includes the following steps.

Step S802: two codebooks or sets of code words, i.e., the codebook C₁ and the codebook C₂, are predefined in the terminal and the system equipment of the communication system.

The codebook C₁ contains K₁ complex matrices of Nₓ×r (1≦r≦Nₓ) and respective columns of each matrix are mutually orthogonal;

wherein C₂ contains K₂ unit column vectors of N_{y}×1, preferably, the column vector C₂ can be represented as

$${C}_{2} = \frac{1}{\sqrt{{N}_{y}}} [ \begin{matrix}1 & {e}^{j 2 πϕ} & … & {{e}^{- j 2 π ( {N}_{y} - 1 ) ϕ} ]}^{T} .\end{matrix}$$

Certainly, C₂ can also be any other complex numbers vectors: such as:

$${C}_{2} = {\frac{1}{\sqrt{{\sum }_{i = 1}^{{N}_{y}} {\vert {c}_{i} \vert}^{2}}} [ {c}_{1} {c}_{2} … {c}_{{N}_{T}} ]}^{T} .$$

Step S804: after the terminal obtains a channel matrix H at a measurement channel, a code word C₁^{k}, the index of which is k₁, is selected as a first parameter from the codebook set C₁ by means of using the H; and a code word C₂^{l}, the index of which is k₂, is selected as a second parameter from the codebook set C₂ by means of using the H;

Step S806: the terminal feeds the index k₁ back to the system equipment; and the terminal feeds the index k₂ back to the system equipment.

Preferably, the system equipment can configure feedback cycles T₁ and T₂ for the first parameter and the second parameter respectively, or the system equipment informs, by means of sending a control message, the terminal to feed back the first parameter or the second parameter.

Preferably, the system equipment uses the latest first parameter and second parameter to find out corresponding code words C₁^{k} and C₂^{l} in the codebook sets C₁ and C₂ respectively, and then the channel coefficient of the user is reconstructed as C₁^{k}^{₁} [symbol] C₂^{k}^{₂} or C₂^{k}^{₂} [symbol] C₁^{k}^{₁}

### Preferable Embodiment II

In this embodiment, the system equipment is provided with 12 antennae at the base station side, which are divided into two groups (as shown in FIG. 7), and each group has 6 antennae, so Nₓ=6 and N_{y}=2, and the construction of the codebook will be described in terms of r=2.

Firstly, a set C₁ containing K₁=2ⁿ^{₁} code words (matrices) of 6×2 is constructed, wherein each matrix C₁^{k}, k=1, . . . K₁ satisfies the property that two columns are mutually orthogonal. Then a set C₂ containing K₂=2ⁿ^{₂} code words (column vectors) is constructed, wherein each column vector C₂^{l}, l=1, . . . K₂ can be represented as:

$${C}_{2}^{1} = [ \begin{matrix}1 \\ {e}^{j {ϕ}_{1}}\end{matrix} ] , {ϕ}_{l} = \frac{π}{{2}^{{n}_{2} + 1}} l + {θ}_{0} , l = 0 , , … {K}_{2} - 1 ,$$

then the final code word set C is constructed as:

$${C}_{i} = {C}_{2}^{l} ⊗ {C}_{1}^{k} , i = 0 , … , {K}_{1} {K}_{2} - 1 , l = ⌊ \frac{i}{{K}_{1}} ⌋ , k = {i}_{mod {K}_{1}} ,$$

where Cᵢ represents the i^{th} code word in the set C. └ ┘ represents taking the maximum integer which is less than or equal to an input parameter, i_{modK}_{₁} represents the remainder of i divided by K₁, ‘ [symbol] ’ represents Kronecker product, for example,

$${C}_{1}^{k} = [ \begin{matrix}{c}_{11} & {c}_{12`} \\ ⋮ & ⋮ \\ {c}_{61} & {c}_{62}\end{matrix} ] , {C}_{2}^{l} = [ \begin{matrix}1 \\ {e}^{j ϕ}\end{matrix} ] ,$$

then C₁^{k} [symbol] C₂^{l} can be written as:

$${C}_{i} = {C}_{2}^{l} ⊗ {C}_{1}^{k} = \frac{1}{\sqrt{2}} [ \begin{matrix}{c}_{11} & {c}_{12} \\ ⋮ & ⋮ \\ {c}_{61} & {c}_{62} \\ {e}^{j ϕ} {c}_{11} & {e}^{j ϕ} {c}_{12} \\ ⋮ & ⋮ \\ {e}^{j ϕ} {c}_{61} & {e}^{j ϕ} {c}_{62}\end{matrix} ] .$$

### Preferable Embodiment III

In this embodiment, the system equipment is provided with 12 antennae at the base station side, which are divided into two groups (as shown in FIG. 7), and each group has 6 antennae, so Nₓ=6 and N_{y}=2, and the construction of the codebook will be described in terms of r=2.

Firstly, a set C₁ containing K₁=2ⁿ^{₁} code words (matrices) of 6×2 is constructed, wherein each matrix C₁^{k}, k=1, . . . K₁ satisfies the property that two columns are mutually orthogonal.

Then a set C₂ containing K₂=2ⁿ^{₂} code words (column vectors) is constructed, wherein each column vector C₂^{l}, l=0, . . . K₂−1 can be represented as:

$${C}_{2}^{1} = [ \begin{matrix}1 \\ {e}^{j {ϕ}_{1}}\end{matrix} ] , {ϕ}_{l} = \frac{π}{{2}^{{n}_{2} + 1}} l + {θ}_{0} , l = 0 , , … {K}_{2} - 1 ,$$

then the final code word set C is constructed as:

$${C}_{i} = {C}_{2}^{l} ⊗ {C}_{1}^{k} , i = 0 , … , {K}_{1} {K}_{2} - 1 , l = ⌊ \frac{i}{{K}_{1}} ⌋ , k = {i}_{mod {K}_{1}} ,$$

where Cᵢ represents the i^{th} code word in the set C. └ ┘ represents taking the maximum integer which is less than or equal to an input parameter, i_{modK}_{₁} represents the remainder of i divided by K₁, ‘ [symbol] ’ represents Kronecker product, for example,

$${C}_{1}^{k} = [ \begin{matrix}{c}_{11} & {c}_{12`} \\ ⋮ & ⋮ \\ {c}_{61} & {c}_{62}\end{matrix} ] , {C}_{2}^{l} = [ \begin{matrix}1 \\ {e}^{j ϕ}\end{matrix} ] ,$$

then C₁^{k} [symbol] C₂^{l} can be written as:

$${C}_{i} = {C}_{2}^{l} ⊗ {C}_{1}^{k} = \frac{1}{\sqrt{2}} [ \begin{matrix}{c}_{11} & {c}_{12} \\ {e}^{j ϕ} {c}_{11} & {e}^{j ϕ} {c}_{12} \\ ⋮ & ⋮ \\ \begin{matrix}{c}_{61} \\ {e}^{j ϕ} {c}_{61}\end{matrix} & \begin{matrix}{c}_{62} \\ {e}^{j ϕ} {c}_{62}\end{matrix}\end{matrix} ] .$$

### Preferable Embodiment IV

In this embodiment, the system equipment is provided with 12 antennae at the base station side, which are divided into two groups (as shown in FIG. 7), and each group has 6 antennae, so Nₓ=6 and N_{y}=2. The construction of the codebook will be described in terms of r=2, and certainly, r can also be any other natural number which is less than or equal to Nₓ.

Firstly, a set C₁ containing K₁ code words (matrices) of 4×2 is constructed, wherein each matrix C₁^{k}, k=1, . . . K₁ satisfies the property that two columns are mutually orthogonal. Then a set C₂ containing K₂=2ⁿ^{₂} code words (column vectors) is constructed, wherein each column vector C₂^{l}, l=1, . . . K₂ can be represented as:

$${C}_{2}^{1} = [ \begin{matrix}1 \\ {e}^{j {ϕ}_{1}}\end{matrix} ] , {ϕ}_{l} = \frac{π}{{2}^{{n}_{2} + 1}} l + {θ}_{0} , l = 0 , … {K}_{2} - 1 ,$$

Then the final code word set C is constructed as:

$${C}_{i} = {C}_{2}^{l} ⊗ {C}_{1}^{k} , i = 0 , … , {K}_{1} {K}_{2} - 1 , l = ⌊ \frac{i}{{K}_{1}} ⌋ , k = {i}_{mod {K}_{1}} ,$$

where Cᵢ represents the i^{th} code word in the set C. └ ┘ represents taking the maximum integer which is less than or equal to an input parameter, i_{modK}_{ᵢ} represents the remainder of i divided by K₁, ‘ [symbol] ’ represents Kronecker product, for example,

$${C}_{1}^{k} = [ \begin{matrix}{c}_{11} & {c}_{12`} \\ ⋮ & ⋮ \\ {c}_{41} & {c}_{42}\end{matrix} ] , {C}_{2}^{l} = \frac{1}{\sqrt{3}} [ \begin{matrix}1 \\ \begin{matrix}{e}^{j ϕ} \\ {e}^{j 2 ϕ}\end{matrix}\end{matrix} ] ,$$

then C₂^{l} [symbol] C₁^{k} can be written as:

$${C}_{i} = {C}_{2}^{l} ⊗ {C}_{2}^{k} = \frac{1}{\sqrt{3}} [ \begin{matrix}{c}_{11} & {c}_{12} \\ ⋮ & ⋮ \\ {c}_{41} & {c}_{42} \\ {e}^{j ϕ} {c}_{11} & {e}^{j ϕ} {c}_{12} \\ ⋮ & ⋮ \\ {e}^{j ϕ} {c}_{41} & {e}^{j ϕ} {c}_{41} \\ {e}^{j 2 ϕ} {c}_{11} & {e}^{j 2 ϕ} {c}_{12} \\ ⋮ & ⋮ \\ {e}^{j 2 ϕ} {c}_{41} & {e}^{j 2 ϕ} {c}_{42}\end{matrix} ] .$$

### Preferable Embodiment V

In this embodiment, the system equipment is provided with 12 antennae at the base station side, which are divided into two groups (as shown in FIG. 7), and each group has 6 antennae, so Nₓ=6 and N_{y}=2. The construction of the codebook will be described in terms of r=2, and certainly, r can also be any other natural number which is less than or equal to Nₓ.

Firstly, a set C₁ containing K₁ code words (matrices) of 4×2 is constructed, wherein each matrix C₁^{k}, k=1, . . . K₁ satisfies the property that two columns are mutually orthogonal. Then a set C₂ containing K₂=2ⁿ^{₂} code words (column vectors) is constructed, wherein each column vector C₂^{l}, l=1, . . . K₂ can be represented as:

$${C}_{2}^{l} = \sqrt{\frac{1}{{\sum }_{i = 1}^{3} {\vert {d}_{i} \vert}^{2}}} [ \begin{matrix}{d}_{1} \\ {d}_{2} \\ {d}_{3}\end{matrix} ] , l = 0 , , … {K}_{2} - 1.$$

Then the final code word set C is constructed as:

$${C}_{i} = {C}_{2}^{l} ⊗ {C}_{1}^{k} , i = 0 , … , {K}_{1} {K}_{2} - 1 , l = ⌊ \frac{i}{{K}_{1}} ⌋ , k = {i}_{mod {K}_{1}} ,$$

where Cᵢ represents the i^{th} code word in the set C. └ ┘ represents taking the maximum integer which is less than or equal to an input parameter, i_{modK}_{₁} represents the remainder of i divided by K₁, ‘ [symbol] ’ represents Kronecker product, for example,

$${C}_{1}^{k} = [ \begin{matrix}{c}_{11} & {c}_{12} \\ ⋮ & ⋮ \\ {c}_{41} & {c}_{42}\end{matrix} ] , {C}_{2}^{l} = \sqrt{\frac{1}{{\sum }_{i = 1}^{3} {\vert {d}_{i} \vert}^{2}}} [ \begin{matrix}{d}_{1} \\ {d}_{2} \\ {d}_{3}\end{matrix} ] ,$$

then C₂^{l} [symbol] C₁^{k} can be written as:

$${C}_{i} = {C}_{2}^{l} ⊗ {C}_{1}^{k} = \frac{1}{\sqrt{{\sum }_{i = 1}^{3} {\vert {d}_{i} \vert}^{2}}} [ \begin{matrix}{d}_{2} {c}_{11} & {d}_{2} {c}_{12} \\ ⋮ & ⋮ \\ {d}_{2} {c}_{41} & {d}_{2} {c}_{42} \\ {d}_{2} {c}_{11} & {d}_{2} {c}_{12} \\ ⋮ & ⋮ \\ {d}_{2} {c}_{41} & {d}_{2} {c}_{41} \\ {d}_{3} {c}_{11} & {d}_{3} {c}_{12} \\ ⋮ & ⋮ \\ {d}_{3} {c}_{41} & {d}_{3} {c}_{42}\end{matrix} ] .$$

### Preferable Embodiment VI

In this embodiment, the system equipment is provided with 12 antennae at the base station side, which are divided into two groups (as shown in FIG. 7), and each group has 6 antennae, so Nₓ=6 and N_{y}=2. The channel coefficient quantization process of the terminal and the channel coefficient reconstruction process after the system equipment receives the feedback from the terminal will be described in terms of r=2. Certainly, r can also be any other natural number which is less than or equal to Nₓ. This embodiment includes the following Steps S902 to S908.

Step S902: both the system equipment and the terminal store two same codebook sets C₁ and C₂ therein, wherein C₁ contains K₁ code words (matrices) of 4×2, wherein each matrix C₁^{k}, k=1, . . . K₁ satisfies the property that two columns are mutually orthogonal. and C₂ contains K₂=2ⁿ^{₂} code words (column vectors), wherein each column vector C₂^{l}, l=1, . . . K₂ can be represented as:

$${C}_{2}^{l} = [ \begin{matrix}1 \\ {e}^{j {ϕ}_{l}}\end{matrix} ] , {ϕ}_{l} = \frac{π}{{2}^{{n}_{2} + 1}} l + {θ}_{0} , l = 0 , , … {K}_{2} - 1.$$

Step S904: the terminal firstly quantizes the channel coefficient matrix H between itself and the system equipment as a code word matrix, the index of which is k₁ in the codebook C₁, wherein the H can be represented as:

$$H = [ \begin{matrix}{h}_{11} & {h}_{12} & {h}_{13} & {h}_{14} & {h}_{15} & {h}_{16} & {h}_{17} & {h}_{18} \\ {h}_{21} & {h}_{22} & {h}_{23} & {h}_{24} & {h}_{25} & {h}_{26} & {h}_{27} & {h}_{28}\end{matrix} ] = [ \begin{matrix}{H}_{1} & {H}_{2}\end{matrix} ] ,$$

the quantification method thereof can be the frequently used maximum norm

$${C}_{1}^{{k}_{1}} = arg {max}_{{C}_{1}^{k} ∈ {C}_{1}} ( {‖ {H}_{1} {C}_{1}^{k} ‖}_{F}^{2} + {‖ {H}_{2} {C}_{1}^{k} ‖}_{F}^{2} ) .$$

Step S906: the terminal can quantize the channel coefficient matrix H as the code word matrix, the index of which is k₂ in the codebook C₂, and the quantification method thereof can also be the frequently used maximum norm

$${C}_{2}^{{k}_{2}} = arg {max}_{{C}_{2}^{k} ∈ {C}_{2}} ( {‖ {H}^{′} {C}_{1}^{k} ‖}_{F}^{2} ) , where$$

$${H}^{′} = {[ \begin{matrix}{h}_{11} & {h}_{13} & {h}_{15} & {h}_{17} & {h}_{21} & {h}_{23} & {h}_{25} & {h}_{27} \\ {h}_{12} & {h}_{14} & {h}_{16} & {h}_{18} & {h}_{22} & {h}_{24} & {h}_{26} & {h}_{28}\end{matrix} ]}^{T} ,$$

wherein the system equipment informs, by means of sending a control message, the terminal to feed back the indexes of k₁ and k₂, for example, the system equipment informs, through a control message, the terminal to feed back k₁ and k₂ in cycles of T₁ and T₂ respectively, and therefore, T₁ can be configured to be far less than T₂.

Step S908: at the sending end, the system equipment uses the latest feedback information k₁ and k₂ acquired thereby to obtain the corresponding code word matrix C₁^{k}^{₁} and vector C₂^{k}^{₂} thereof, and then the channel coefficient of the terminal is calculated as C=C₁^{k}^{₁} [symbol] C₂^{k}^{₂} or C=C₂^{k}^{₂} [symbol] C₁^{k}^{₁} according to the sequence number of the antennae.

### Preferable Embodiment VII

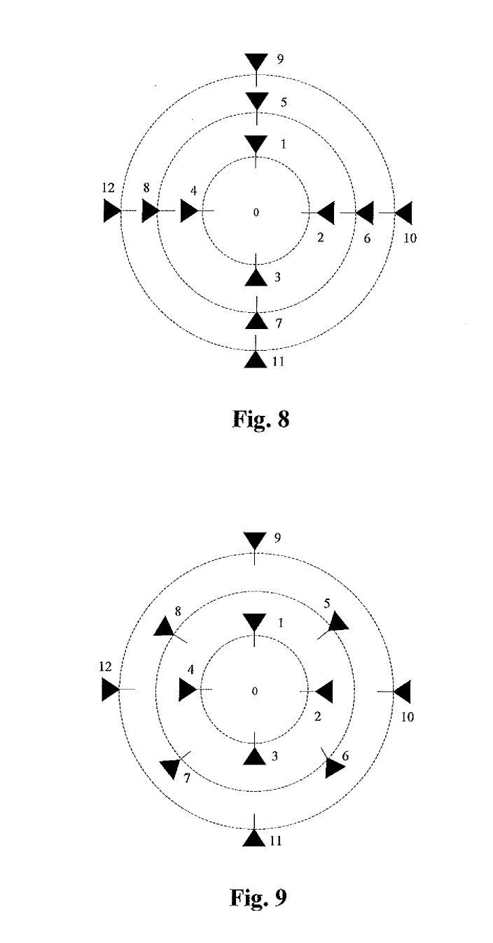

In this embodiment, the system equipment is provided with 12 antennae at the base station side, which are placed to be three-layer circular arrays, and the specific placement thereof can be shown as FIG. 8 or FIG. 9, and certainly, there may also be other similar placement, 4 antennae are placed in each circular, so Nₓ=4 and N_{y}=3, and the construction of the codebook will be described in terms of r=2.

Firstly, a set C₁ containing K₁=2ⁿ^{₁} code words (matrices) of 4×2 is constructed, wherein each matrix C₁^{k}, k=1, . . . K₁ satisfies the property that two columns are mutually orthogonal. Then a set C₂ containing K₂=2ⁿ^{₂} code words (column vectors) is constructed, wherein each column vector C₂^{l}, l=0, . . . K₂−1 can be represented as:

$${C}_{2}^{l} = \frac{1}{{α}_{l}} [ \begin{matrix}1 \\ {e}^{j {ϕ}_{{i}_{1}}} \\ {e}^{j 2 {ϕ}_{{i}_{2}}}\end{matrix} ] , l = 0 , L {K}_{2} - 1 ;$$

then the final code word set C is constructed as:

$${C}_{i} = {C}_{2}^{l} ⊗ {C}_{1}^{k} , i = 0 , L , {K}_{1} {K}_{2} - 1 , l = ⌊ \frac{i}{{K}_{1}} ⌋ , k = {i}_{mod {K}_{1}} ,$$

where Cᵢ represents the i code word in the set C. └ ┘ represents taking the maximum integer which is less than or equal to an input parameter, i_{modK}_{₁} represents the remainder of i divided by K₁, ‘ [symbol] ’ represents Kronecker product, for example,

$${C}_{1}^{k} = [ \begin{matrix}{c}_{11} & {c}_{12} \\ M & M \\ {c}_{41} & {c}_{42}\end{matrix} ] , {C}_{2}^{l} = \frac{1}{{α}_{l}} [ \begin{matrix}1 \\ {e}^{j {ϕ}_{{i}_{1}}} \\ {e}^{j 2 {ϕ}_{{i}_{2}}}\end{matrix} ] ,$$

then C₂^{l} [symbol] C₁^{k} can be written as:

$${C}_{i} = {C}_{2}^{l} ⊗ {C}_{1}^{k} = \frac{1}{{β}_{i}} [ \begin{matrix}{c}_{11} & {c}_{12} \\ M & M \\ {c}_{41} & {c}_{22} \\ M & M \\ {e}^{j {ϕ}_{{i}_{2}}} {c}_{11} & {e}^{j {ϕ}_{{i}_{2}}} {c}_{12} \\ M & M \\ {e}^{j {ϕ}_{{i}_{2}}} {c}_{41} & {e}^{j {ϕ}_{{i}_{2}}} {c}_{42 }\end{matrix} ] .$$

By means of respectively using the number of the columns of the planar antenna array and the number of antennae in each row of the planar antenna array to generate codebooks respectively and feeding back the channel state information, the above-mentioned embodiments provide a method and device for feeding back channel state information, which can effectively quantize channel coefficients, and reduce the expenditure of feeding back, thus both improving system robustness and saving feedback bandwidth resources at the same time. It should be noted that not all the above-mentioned embodiments have these technology effects, and some of the technology effects can be achieved by certain preferred embodiments.

Obviously, those skilled in the art shall understand that the above-mentioned modules and steps of the disclosure can be realized by using general purpose calculating device, can be integrated in one calculating device or distributed on a network which consists of a plurality of calculating devices. Alternatively, the modules and the steps of the disclosure can be realized by using the executable program code of the calculating device. Consequently, they can be stored in the storing device and executed by the calculating device, or they are made into integrated circuit module respectively, or a plurality of modules or steps thereof are made into one integrated circuit module. In this way, the disclosure is not restricted to any particular hardware and software combination.

The descriptions above are only the preferable embodiment of the disclosure, which are not used to restrict the disclosure. For those skilled in the art, the disclosure may have various changes and variations. Any amendments, equivalent substitutions, improvements, etc. within the principle of the disclosure are all included in the scope of the protection of the disclosure.

What is claimed is:

1-13. (canceled)

14. A method for feeding back channel state information, comprising:
generating a first codebook in a terminal and a system equipment of a communication system by using a number of antennae in each row of a planar antenna array of the system equipment;
generating a second codebook in the terminal and the system equipment by using a number of columns of the planar antenna array; and
feeding back channel state information from the terminal to the system equipment by using the first codebook and the second codebook.

15. The method according to claim 14, wherein the step of generating the first codebook in the terminal and the system equipment by using the number of antennae in each row of the planar antenna array comprises:
constructing a plurality of K₁ complex matrices of Nₓ×r, wherein K₁ is a number of matrices of a quantification channel and is a natural number, and Nₓ is the number of the antennae in each row of the planar antenna array, 1≦r≦Nₓ, and respective columns of each complex matrix are mutually orthogonal.

16. The method according to claim 14, wherein the step of generating the second codebook in the terminal and the system equipment by using the number of columns of the planar antenna array comprises:
constructing a plurality of K₂ unit column vectors of N_{y}×1, wherein N_{y} is the number of columns of the planar antenna array.

17. The method according to claim 16, wherein the step of constructing K₂ unit column vectors of N_{y}×1 comprises:
constructing a column vector C2, wherein C2 is one of
$${C}_{2} = {\frac{1}{\sqrt{{N}_{y}}} [ \begin{matrix}1 & {e}^{j ϕ} & & {e}^{- j ( {N}_{y} - 1 ) ϕ}\end{matrix} ]}^{T} ; and$$
$${C}_{2} = {\frac{1}{\sqrt{{\sum }_{i = 1}^{{N}_{y}} {\vert {c}_{i} \vert}^{2}}} [ \begin{matrix}{c}_{1} & {c}_{2} & & {c}_{{N}_{y}}\end{matrix} ]}^{T} ,$$
wherein φ is a vector angle, and c₁ c₂ [symbol] c_{N}_{_{y}} are complex numbers.

18. The method according to claim 1, wherein the step of feeding back the channel state information from the terminal to the system equipment by using the first codebook and the second codebook comprises one of:
calculating one of a Kronecker product of the first codebook and the second codebook and a Kronecker product of the second codebook and the first codebook to get a third codebook, and feeding back from the terminal to the system equipment a third index, wherein the third index is a corresponding index of a quantized channel state information in the third codebook; and
feeding back from the terminal to the system equipment a first index and a second index, wherein the first index is a corresponding index of a quantized channel state information in the first codebook, and the second index is a corresponding index of a quantized channel state information in the second codebook.

19. A device for feeding back channel state information, comprising:
a first generation module configured to generate a first codebook by using a number of antennae in each row of a planar antenna array of a system equipment of a communication system;
a second generation module configured to generate a second codebook by using a number of columns of the planar antenna array; and
a first feedback module configured to feed back channel state information to the system equipment by using the first codebook and the second codebook.

20. The device according to claim 19, wherein the first generation module comprises:
a first construction module configured to construct a plurality of K₁ complex matrices of Nₓ×r, wherein K₁ is a number of matrices of a quantification channel and is a natural number, and Nₓ is the number of the antennae in each row of the planar antenna array, 1≦r≦Nₓ, and respective columns of each complex matrix are mutually orthogonal.

21. The device according to claim 19, wherein the second generation module comprises:
a second construction module configured to construct a plurality of K₂ unit column vectors of N_{y}×1, wherein N_{y} is the number of columns of the planar antenna array.

22. The device according to claim 21, wherein
the second construction module is configured to construct column vector C2, wherein C2 is one of:
$${C}_{2} = {\frac{1}{\sqrt{{N}_{y}}} [ \begin{matrix}1 & {e}^{j ϕ} & & {e}^{- j ( {N}_{y} - 1 ) ϕ}\end{matrix} ]}^{T} ; and$$
$${C}_{2} = {\frac{1}{\sqrt{{\sum }_{i = 1}^{{N}_{y}} {\vert {c}_{i} \vert}^{2}}} [ \begin{matrix}{c}_{1} & {c}_{2} & & {c}_{{N}_{y}}\end{matrix} ]}^{T} ,$$
wherein φ is a vector angle, and c₁ c₂ [symbol] c_{N}_{_{y}} are complex numbers.

23. The device according to claim 19, wherein the first feedback module comprises one of:
a processing module configured to one of calculate a Kronecker product of the first codebook and the second codebook and calculate a Kronecker product of the second codebook and the first codebook to get a third codebook, and a second feedback module configured to feed back a third index to the system equipment, wherein the third index is a corresponding index of a quantized channel state information in the third codebook; and
a third feedback module configured to feed back a first index and a second index to the system equipment, wherein the first index is a corresponding index of a quantized channel state information in the first codebook, and the second index is a corresponding index of a quantized channel state information in the second codebook.

24. A method for feeding back channel state information, comprising:
generating a first codebook in a terminal and a system equipment of a communication system by using a first parameter of an antenna array of the system equipment;
generating a second codebook in the terminal and the system equipment of a communication system by using a second parameter of the antenna array;
feeding back channel state information from the terminal to the system equipment by one of using the first codebook and the second codebook and using a third codebook generated by the first codebook and the second codebook; and
wherein the product of the first parameter and the second parameter is a number of parameters contained in the antenna array, and the first parameter and the second parameter are natural numbers.

25. The method according to claim 24, wherein one of
the first parameter is the number of antennae in each row of the antenna array, and the second parameter is the number of antennae in each column of the antenna array;
the first parameter is the number of the antennae in each column of the antenna array, and the second parameter is the number of the antennae in each row of the antenna array;
the first parameter is the number of loops when the antenna array is placed as an circular array, and the second parameter is the number of antennae in each loop of the antenna array; and
the first parameter is the number of antennae in each loop of the antenna array, and the second parameter is the number of loops when the antenna array is placed as an circular array.

26. A device for feeding back channel state information, comprising:
a first generation module configured to generate a first codebook by using a first parameter of an antenna array of a system equipment of a communication system;
a second generation module configured to generate a second codebook by using a second parameter of the antenna array;
a first feedback module configured to feed back channel state information to the system equipment by one of using the first codebook and the second codebook and by using a third codebook generated by the first codebook and the second codebook; and
wherein the product of the first parameter and the second parameter is a number of parameters contained in the antenna array, and the first parameter and the second parameter are natural numbers.

27. The method according to claim 15, wherein the step of feeding back the channel state information from the terminal to the system equipment by using the first codebook and the second codebook comprises one of:
calculating one of a Kronecker product of the first codebook and the second codebook and a Kronecker product of the second codebook and the first codebook to get a third codebook, and feeding back from the terminal to the system equipment a third index, wherein the third index is a corresponding index of a quantized channel state information in the third codebook; and
feeding back from the terminal to the system equipment a first index and a second index, wherein the first index is a corresponding index of a quantized channel state information in the first codebook, and the second index is a corresponding index of a quantized channel state information in the second codebook.

28. The method according to claim 16, wherein the step of feeding back the channel state information from the terminal to the system equipment by using the first codebook and the second codebook comprises one of:
calculating one of a Kronecker product of the first codebook and the second codebook and a Kronecker product of the second codebook and the first codebook to get a third codebook, and feeding back from the terminal to the system equipment a third index, wherein the third index is a corresponding index of a quantized channel state information in the third codebook; and
feeding back from the terminal to the system equipment a first index and a second index, wherein the first index is a corresponding index of a quantized channel state information in the first codebook, and the second index is a corresponding index of a quantized channel state information in the second codebook.

29. The method according to claim 17, wherein the step of feeding back the channel state information from the terminal to the system equipment by using the first codebook and the second codebook comprises one of:
calculating one of a Kronecker product of the first codebook and the second codebook and a Kronecker product of the second codebook and the first codebook to get a third codebook, and feeding back from the terminal to the system equipment a third index, wherein the third index is a corresponding index of a quantized channel state information in the third codebook; and
feeding back from the terminal to the system equipment a first index and a second index, wherein the first index is a corresponding index of a quantized channel state information in the first codebook, and the second index is a corresponding index of a quantized channel state information in the second codebook.

30. The device according to claim 20, wherein the first feedback module comprises one of:
a processing module configured to one of calculate a Kronecker product of the first codebook and the second codebook and calculate a Kronecker product of the second codebook and the first codebook to get a third codebook, and a second feedback module configured to feed back a third index to the system equipment, wherein the third index is a corresponding index of a quantized channel state information in the third codebook; and
a third feedback module configured to feed back a first index and a second index to the system equipment, wherein the first index is a corresponding index of a quantized channel state information in the first codebook, and the second index is a corresponding index of a quantized channel state information in the second codebook.

31. The device according to claim 21, wherein the first feedback module comprises one of:
a processing module configured to one of calculate a Kronecker product of the first codebook and the second codebook and calculate a Kronecker product of the second codebook and the first codebook to get a third codebook, and a second feedback module configured to feed back a third index to the system equipment, wherein the third index is a corresponding index of a quantized channel state information in the third codebook; and
a third feedback module configured to feed back a first index and a second index to the system equipment, wherein the first index is a corresponding index of a quantized channel state information in the first codebook, and the second index is a corresponding index of a quantized channel state information in the second codebook.

32. The device according to claim 22, wherein the first feedback module comprises one of:
a processing module configured to one of calculate a Kronecker product of the first codebook and the second codebook and calculate the Kronecker product of the second codebook and the first codebook to get a third codebook; and a second feedback module configured to feed back a third index to the system equipment, wherein the third index is a corresponding index of a quantized channel state information in the third codebook; and
a third feedback module configured to feed back a first index and a second index to the system equipment, wherein the first index is a corresponding index of a quantized channel state information in the first codebook, and the second index is a corresponding index of a quantized channel state information in the second codebook.
